(19) United States
(12) Patent Application Publication
(10) Pub. No.: US 2010/0163707 A1
(43) Pub. Date: Jul. 1, 2010

(54) ICE MAKING ASSEMBLY FOR A REFRIGERATOR

(75) Inventor: Dae-Yeon Kim, Changwon City (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/601,111

(22) PCT Filed: May 20, 2008
(86) PCT No.: PCT/KR08/02811

§ 371 Date: Feb. 25, 2010

(30) Foreign Application Priority Data
May 23, 2007 (KR) 10-2007-0050519

(51) Int. Cl. B28B 7/24

(52) U.S. Cl. 249/120

(57) ABSTRACT

The present invention relates to an ice making assembly, which can separate ice more effectively as the twisting moment applied to a tray is freely transferred to far side of a rotation shaft.

### TECHNICAL FIELD

This document relates to an ice making assembly for a refrigerator.

### BACKGROUND ART

Generally, a refrigerator is a domestic appliance for storing various foods in either a frozen or a refrigerated condition.

In the refrigerator, a freezing chamber and a refrigerating chamber are provided, and an ice maker for producing ice is installed in the freezing chamber. The ice maker includes a water tank in which water for making ice cubes is stored, a tray in which ice cubes are substantially produced as water stored in the water tank is supplied therein, and a container in which ice cubes produced in the tray are stored.

In detail, water stored in the water tank is supplied to the tray by means of the operation of a valve device. And, ice produced in the tray is separated from the tray by a twisting operation of the tray, and it is dropped into the container and stored therein. Further, the stored ice is discharged as the container is drawn from the other side of a refrigerating chamber door or a freezing chamber door.

### DISCLOSURE OF INVENTION

### Technical Problem

However, this kind of conventional ice maker for a refrigerator has following problems.

In detail, ice produced in the tray is separated by the twisting operation of the tray and is dropped into the container. However, the tray is formed to have a shape of a hexahedron, where a side cross-section is a rectangular shape, and is rotated around a rotation shaft protruded at a front and rear surfaces. Accordingly, since a twisting moment is not properly exerted on an edge portion of the tray which is relatively spaced apart from the rotation shaft, the produced ice is not effectively separated therefrom.

### Technical Solution

The present invention is proposed to resolve these conventional problems, and an object of the present invention is to provide an ice making assembly which can separate ice more effectively by transferring a twisting moment exerted on a tray to far side of the rotation shaft.

To achieve the objects of the present invention, as embodied and broadly described herein, there is provided an ice making assembly for a refrigerator, including a water tank in which water for making ice is stored; a tray having a plurality of partitioned spaces which are to receive water supplied from the water tank; a frame where a limiting element for limiting the rotation of the tray is formed at one side thereof; a container in which ice produced in the tray is stored; and a connection bar extended from the center of rotation of the tray to be connected to an edge of the tray.

### Advantageous Effects

By means of the ice making assembly for the refrigerator according to preferred embodiments of the present invention, the twisting moment is effectively transferred to edge portions, relatively spaced apart from the rotation shaft of the tray where ice is produced. Therefore, since ice produced in the tray is easily separated by a small force, the convenience of use of the ice making assembly is advantageously improved.

### BRIEF DESCRIPTION OF THE DRAWINGS

FIG. 1 is an external perspective view showing an ice making assembly for a refrigerator according to an embodiment of the present invention.

FIG. 2 is an external perspective view showing an ice making assembly for a refrigerator where a case is removed therefrom.

FIG. 3 is an external perspective view of a water tank constituting an ice making assembly according to an embodiment of the present invention.

FIG. 4 is a cross-sectional view taken along line I-I of FIG. 3.

FIG. 5 is a cross-sectional view taken along line II-II of FIG. 3.

FIG. 6 is a front perspective view of a tray assembly according to an embodiment of the present invention.

FIG. 7 is a rear perspective view of the tray assembly.

FIG. 8 is a front view showing a state that a tray according to an embodiment of the present invention is in its original position.

FIG. 9 is a front view showing a state that a tray is rotated at a predetermined angle.

FIG. 10 is a front view showing a state that a tray is rotated as much as possible.

### MODE FOR THE INVENTION

Hereinafter, the scope of the present invention will be explained with reference to accompanying drawings. It is to be pointed out that the embodiments of the present invention do not limit the scope of the invention, but on the contrary it has to be understood that many modifications, additions, variations or substitutions may be resorted to the present invention, without altering its spirit or departing from its scope of protection, as it is defined in the appended claims.

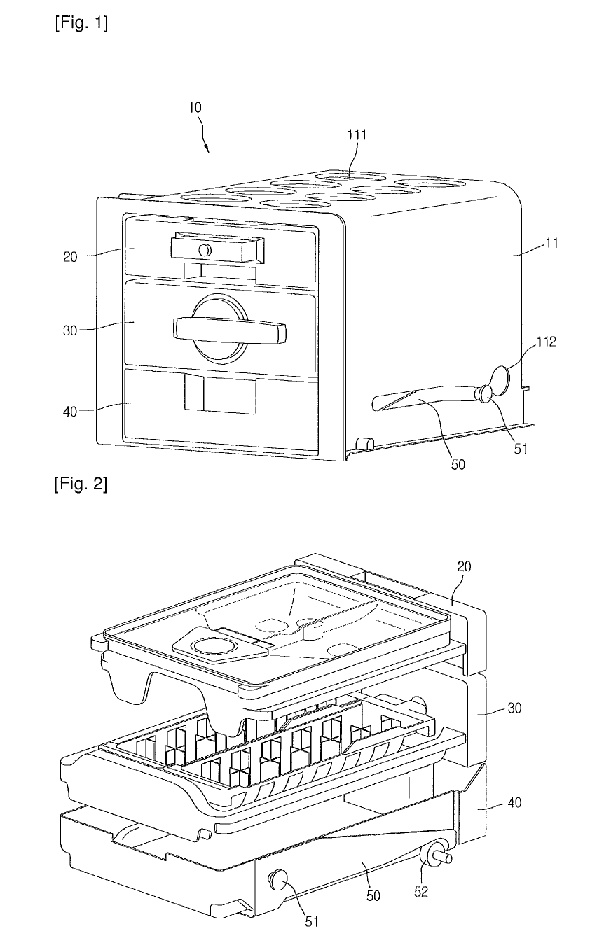

FIG. 1 shows an ice making assembly for a refrigerator according to an embodiment of the present invention in an external perspective view, and FIG. 2 shows an ice making assembly for a refrigerator, where a case thereof is removed, in an external perspective view.

Referring to FIGS. 1 and 2, the ice making assembly 10 for the refrigerator to the embodiment of the present invention includes a case 11, a water tank 20 received in the case 11, a tray assembly 30 where ice is produced, a container 40 in which ice is stored, and a guide 50 which enables the container 40 to be drawn in a multi-stage manner.

In detail, the water tank 20 is disposed at an uppermost portion of the case 11, and the tray assembly 30 is disposed below the water tank. Further, the container 40 is disposed below the tray assembly 30. Therefore, as water stored in the water tank 20 is dropped into the tray assembly 30, ice is produced in the tray assembly 30. And, the produced ice is dropped into the container 40 by the twisting operation of the tray assembly 30. Further, the container 40 is forwardly drawn by the guide 50 in a multi-stage manner.

Meanwhile, a stopper 51 is protruded at a side of the guide 50, and a guide hole 112 for guiding the movement of the stopper 51 is formed long in a front and rear direction. In detail, the stopper 51 is moved in a state where it is perforated and inserted in the guide hole 112. And, if the guide 50 is forwardly drawn as much as possible, the stopper 51 is caught by a front end of the guide hole 112. Accordingly, the guide 50 is prevented from being completely detached from the case 11.

Also, a plurality of cold air feed holes 111 are formed in an upper surface of the case 11, so that cold air in the freezing chamber is transferred to the tray assembly 30.

Hereinafter, each part of the ice making assembly 10 will be explained in detail with reference to the accompanying drawings.

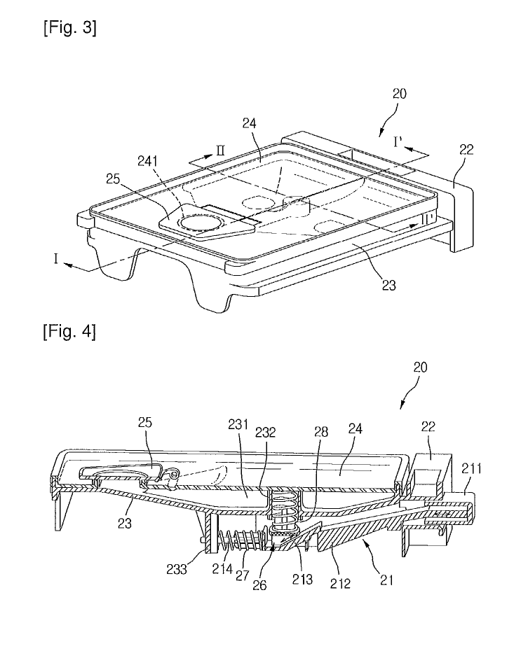

FIG. 3 shows a water tank constituting an ice making assembly according to an embodiment of the present invention in an external perspective view.

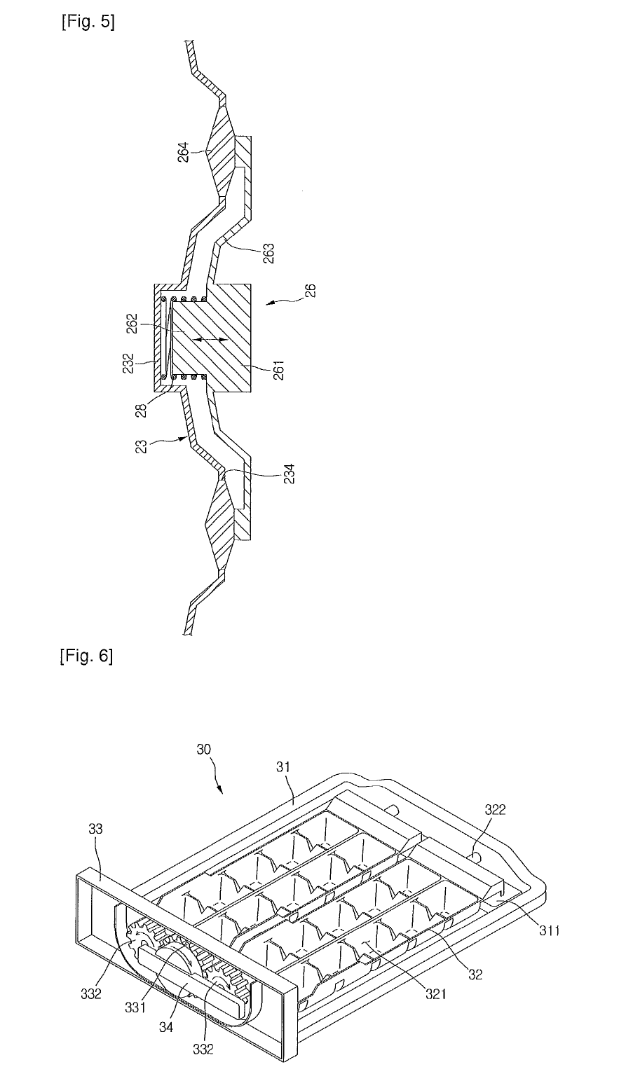

Referring to FIG. 3, the water tank 20 according to the embodiment of the present invention includes a front cover 22 forming a front portion of the water tank, a tank body 23 extended from a rear surface of the front cover 22, and a tank cover 24 covering an open, upper surface of the tank body 23. And, a button assembly 21 (see FIG. 4) perforates a front surface of the front cover 22 and is extended in a rear direction. Further, a valve assembly 26 (see FIG. 5) is arranged transversal to the tank body 23, and it is interlocked with the button assembly 21 and moved in a vertical direction.

In detail, a water feed hole 241 is formed at a rear center of the tank cover 24, and the water feed hole 241 is opened or closed by a lid 25. The lid 25 is pivotably installed in the tank cover 24.

Hereinafter, a structure of the tank body 23 and structures of the valve assembly 26 and button assembly 21 will be explained in detail with reference to the cross-sectional view.

FIG. 4 is a cross-sectional view taken along line I-I of FIG. 3.

Referring to FIG. 4, a center sleeve 232 is upwardly protruded from a bottom surface of the tank body 23. And, at the center of the tank body 23, a partition rib 231 is formed long in a front and rear direction. Accordingly, an inner space of the tank body 23 is equally divided into a left space and a right space by the partition rib 231. And, the center sleeve 232 is formed on a line where the partition rib 231 is extended. That is, the center sleeve 232 is equally divided into a right and left side by a partition rib 231. In detail, a lower end of the center sleeve 232 is opened, and the center sleeve 232 is formed to have a hollow shape. The valve assembly 26 is received in the center sleeve 232. And, the bottom surface of the tank body 23 is inclined to the center sleeve 232, so that a shape which allows the supplied water to be collected is formed. And, a support rib 233 is downwardly extended from the bottom surface of the tank body 23 to support one end of the button assembly 21. In the support rib 233, a hole for receiving an end of the button assembly 21 is formed.

More specifically, the button assembly 21 includes a button head 211, a button body 212 extended from the button head 211, a valve contact 213 downwardly extended from an upper surface of an end of the button body 212 at a predetermined angle, and a guide rod 214 extended from an end of the valve contact 213. And, an end of the guide rod 214 is perforated and inserted in the support rib 233.

Also, an elastic element 27 is fitted to an outer circumferential surface of the guide rod 214, so that it serves to return the button assembly 21 to its initial position when external force is removed therefrom after exerting on the button assembly 21.

In detail, the button head 211 is perforated and inserted in the front cover 22, and it is protruded from a front of the front cover 22 and maintained. And, when a refrigerator door is closed, the button head is pressed in a state where it is contacted with a rear surface of the door. And then, the whole button assembly 21 is moved to a rear of the water tank 20, and therefore the elastic element 27 is retracted.

Meanwhile, the valve assembly 26 is seated on an upper surface of the valve contact 213. Specifically, a lower end of the valve assembly 26 contacting with the valve contact 213 is inclined at the same angle as the valve contact 213. Accordingly, when the button assembly 21 is moved in a front and rear direction, the valve assembly 26 is moved in a vertical direction. And, the valve assembly 26 is lifted and dropped within the center sleeve 232 in a vertical direction.

FIG. 5 is a cross-sectional view taken along line of FIG. 3.

Referring to FIG. 5, the center sleeve 232 is protruded at a point where the tank body 23 is equally divided into a left side end and a right side end. And, a discharge hole 234 is respectively formed at points which are spaced apart from the center sleeve 232 at a predetermined distance in right and left directions. And, the bottom surface of the tank body 23 is inclined toward the discharge hole 234, water stored in the tank body 23 is dropped to the tray assembly 30 via the discharge hole 234.

Meanwhile, the valve assembly 26 includes a body 261, an arm 263 extended from the body 261 in either side, and a cap 264 provided at an end of the arm 263. Specifically, a guide boss 262 is protruded from an upper surface of the body 261, and an elastic element 28 is fitted to an outer circumferential surface of the guide boss 262. And, an end of the arm 263 is upwardly bent and is extended to a predetermined length, and the cap 264 is attached to the end. And, the cap 264 perforates the discharge hole 234 and protrudes from the bottom surface of the tank body 23. And, a bottom surface of the body 261 is inclined at the same angle as the valve contact 213 of the button assembly 21. And, when the button assembly 21 is moved in the front and rear direction, the body 261 is moved in the vertical direction. In that case, the guide boss 262 is received in the center sleeve 232. And, the elastic element 28 is compressed and returned to its original state repeatedly according to the movement of the guide boss 262. And, in case the valve assembly 26 is stopped, the discharge hole 234 is maintained as being closed by the cap 264. And, if the button assembly 21 is moved rearward, the valve assembly 26 is raised and the cap 264 is separated from the discharge hole 234. Accordingly, water stored in the water tank 20 is supplied to the discharge hole 234 as the discharge hole 234 is opened.

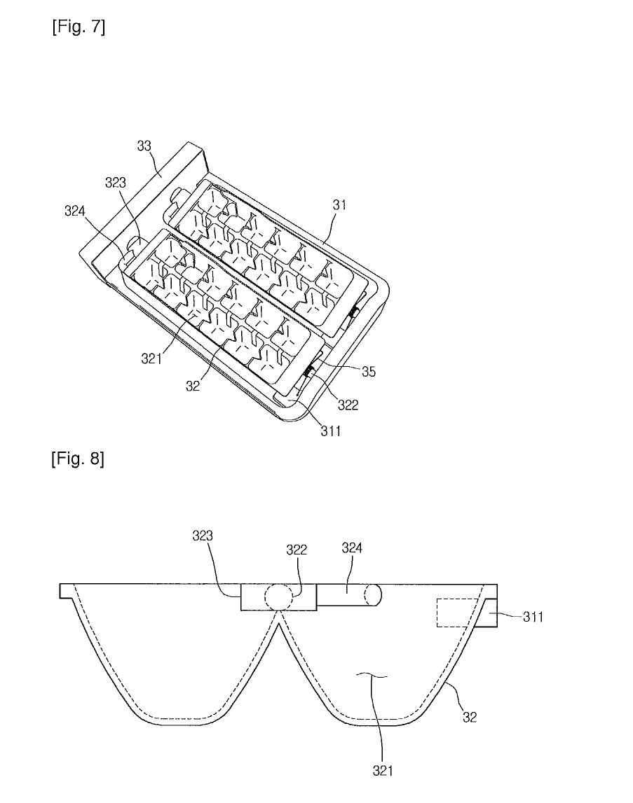

FIG. 6 shows a tray assembly according to an embodiment of the present invention in a front perspective view, and FIG. 7 shows the tray assembly in a rear perspective view.

Referring to FIGS. 6 and 7, the tray assembly 30 according to the embodiment of the present invention includes a gear box 33 forming a front portion of the tray assembly, a frame 31 extended along a bottom surface of the gear box 33, and a pair of trays 32 rotatably connected to the a bottom surface of the gear box 33.

In detail, a plurality of gears are installed in the gear box 33, and a rotation lever 34 which is connected to one of the plurality of gears is installed at a front surface of the gear box 33. More specifically, the plurality of gears include a drive gear 331 connected with the rotation lever 34, and a driven gear 332 mated with the drive gear 331 and connected with each of trays 32. Therefore, if the rotation lever 34 is rotated, the drive gear 331 is rotated and the driven gear 332 mated with the drive gear 331 is also rotated. And, the tray 32 connected to the drive gear 331 is rotated.

Meanwhile, the frame 31 is formed in the shape of a rectangular band which surrounds a contour of the tray 32. And, the tray 32 is received in the frame 31. And, a support projection 311 supporting a side edge of the tray 32 is protruded from a rear side surface of the frame 31.

Specifically, the support projection 311 is formed in numbers corresponding to the number of the tray 32, so that it supports the side edge of the tray 32. And, the support projection 311 serves as a stopper which produces the twisting moment by limiting the rotation of the tray 32. Hereinafter, it will be explained in detail with reference to the accompanying drawings.

In the tray 32, a plurality of ice cubes 321 are depressed to a predetermined depth and are formed. And, a gear connection 323 is extended to a center of a front end of the tray 32, and the gear connection 323 is perforated and inserted into a center of each of the corresponding driven gear 332. And, a shaft 322 is extended at a center of a rear end of the tray 32, and the shaft 322 is inserted into an inner side surface of the rear end of the frame 31. And, an elastic element 35 such as a torsion spring is fitted to an outer circumferential surface of the shaft 322 so as to return the tray 32 to its initial point after the tray 32 is rotated. Here, an end of the elastic element 35 is fixed to the support projection 311, and the other end is fixed to an outer circumferential surface of the tray 32. Therefore, the tray 32 is returned to its initial point by the elastic force accumulated when the tray 32 is rotated.

Also, a connection bar 324 connecting a side surface of the gear connection 323 with an edge of the tray 32 is further formed. The connection bar 324 is bent and formed in the shape of L. And, the connection bar 324, gear connection 323 and shaft 322 together with the tray 32 may be integrally formed by an injection molding process. An edge of the tray 32, where the connection bar 324 is formed, and an edge of the tray 32, which is supported by the support projection 311, are positioned on the same line. That is, if an end of the connection bar 324 is formed at a right side, front edge of the tray 32, a right side, rear edge of the tray 32 is supported by the support projection 311. And, in order to separate ice produced in the ice cubes 321, the tray 32 is rotated in a direction where the edge of the tray 32 contacting with the support projection 311 is separated from the support projection 311.

Since one end of the connection bar 324 is extended from the gear connection 323 and the other end is connected to an edge portion of the tray 32, the twisting moment exerted on the tray 32 is freely transferred to the edge portion of the tray 32.

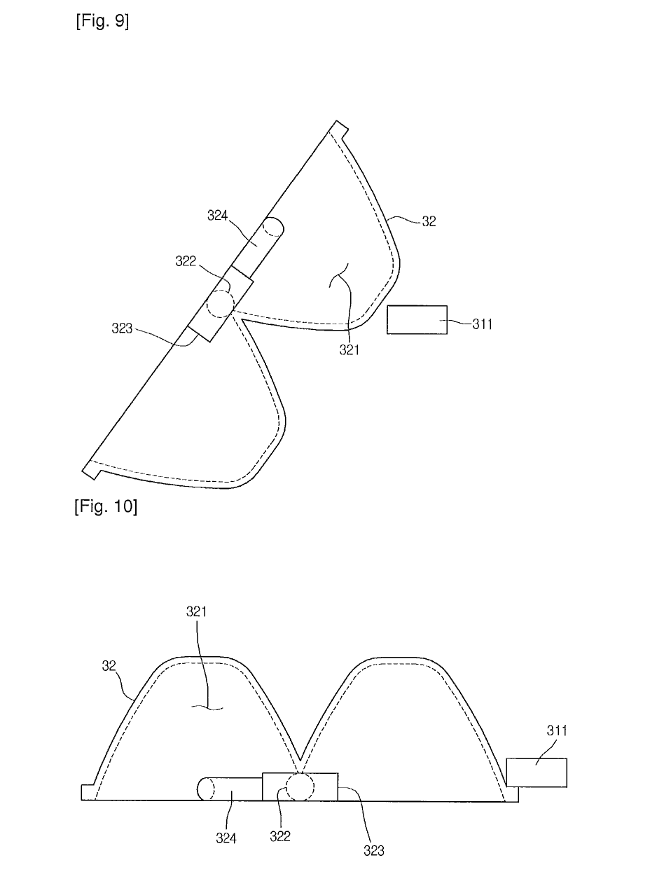

FIG. 8 shows a state where a tray according to an embodiment of the present invention is in its original position in a front view, FIG. 9 shows a state where a tray is rotated at a predetermined angle in a front view, and FIG. 10 shows a state where a tray is rotated as much as possible in a front view.

Referring to FIG. 8, in case the tray is in its original position, the right side, rear edge of the tray 32 is supported by the support projection 311. In this state, if the ice making process is operated, water supplied to the ice cubes 321 starts to freeze into ice. And, if the rotation lever 34 is rotated (rotated in a clockwise direction in FIG. 6) after finishing the ice making process, the pair of trays 32 are rotated in a counter-clockwise direction.

Referring to FIG. 9, if the tray 32 starts to rotate, the right side, rear edge of the tray 32 is separated from the support projection 311.

Referring to FIG. 10, in a state where the tray is rotated as much as possible, the left side, rear edge of the tray 32 is contacted with the bottom surface of the support projection 311. In this state, the rotation lever 34 is further rotated, the tray 32 is twisted. And, ice attached to the ice cubes 321 is separated therefrom, as the tray 32 is twisted. Here, the twisting moment applied to the tray 32 is transferred to a side end of the tray 32 by the connection bar 324. Therefore, there is an advantage in that ice is effectively separated as the twisting operation of the tray 32 is freely accomplished.

1. An ice making assembly for a refrigerator, comprising:
a water tank in which water for making ice is stored;
a tray having a plurality of partitioned spaces which are to receive water supplied from the water tank;
a frame surrounding a contour of the tray, where a limiting element for limiting the rotation of the tray is formed at one side thereof;
a container in which ice produced in the tray is stored; and
a connection bar extended from the center of rotation of the tray to be connected to an edge of the tray.

2. The ice making assembly for the refrigerator according to claim 1, wherein the connection bar is configured to bent at least one time.

3. The ice making assembly for the refrigerator according to claim 1, wherein the limiting element is a support projection protruded from an inner surface of the frame.

4. The ice making assembly for the refrigerator according to claim 1, wherein the connection bar is connected to an edge opposite to the edge of the tray supported by the limiting element.

5. The ice making assembly for the refrigerator according to claim 1, wherein the water tank comprises:
a tank body, in which water is stored, provided with a discharge hole formed in a bottom surface thereof;
a button assembly extended from a front to a rear at a lower side of the tank body;
a valve assembly interlocking with the button assembly to open and close the discharge hole selectively, and
a tank cover covering an upper, opened surface of the tank body.

6. The ice making assembly for the refrigerator according to claim 5, wherein the valve assembly is moved in a vertical direction when the button assembly is moved in a front and rear direction.

7. The ice making assembly for the refrigerator according to claim 5, wherein a contact surface between the button assembly and the valve assembly is inclined at a predetermined angle.

8. The ice making assembly for the refrigerator according to claim 1, wherein the container can be drawn in a multi-stage manner.

9. The ice making assembly for the refrigerator according to claim 1, wherein at least two trays are arranged from side to side.

10. The ice making assembly for the refrigerator according to claim 9, wherein a front surface of the frame is provided with driven gears connected to the rotation shaft of the trays respectively,
a drive gear mated with the driven gears, and
a rotation lever connected to the drive gear.
